(19) United States
(12) Patent Application Publication
(10) Pub. No.: US 2010/0034928 A1
(43) Pub. Date: Feb. 11, 2010

(54) PRINTED ANTIFOG FILMS

(76) Inventors: Mario Paleari, Pogliano Milanese (IT); Roberto Cantoni, Segrate (IT); Vittorio Perego, Busto Arsizio (IT)

Correspondence Address: Law Department;Sealed Air Corporation, Post Office Box 464, Duncan, SC, 29334, US

(21) Appl. No.: 12/450,689

(22) PCT Filed: Apr. 2, 2008
(86) PCT No.: PCT/EP2008/053938

§ 371 Date: Oct. 6, 2009

(30) Foreign Application Priority Data
Apr. 19, 2007 (EP) 07106466.1

(51) Int. Cl. A23B 4/10; B32B 3/10; C08L 27/08; B65D 79/00

(52) U.S. Cl. 426/87; 428/203; 524/551; 426/125

(57) ABSTRACT

The present invention relates to printed antifog films suitable for the packaging of food products having an improved ability to maintain their antifogging properties after being wound up into a roll and to the packages obtained therefrom. The films of the invention comprise an overprint varnish applied over the printed image on the antifog film, said overprint varnish comprising a vinylidene chloride polymer and a surfactant. The printed antifog film may be manufactured using conventional equipment by applying an overprint varnish in the final print station of the printing process.

### TECHNICAL FIELD

The present invention relates to antifog films useful for packaging food products, and more particularly to printed antifog films having an improved ability to maintain their antifogging properties after being wound into a roll.

### BACKGROUND ART

Refrigerated food products are often sold packaged in a tray covered with a transparent plastic film. Typically, the plastic film covering the tray does not touch most of the packaged food so that the consumer may see clearly through the plastic film to view the food product in the package. When a food product, especially one with a high-moisture content, is packaged in this manner and is refrigerated the moisture present inside the package condenses on the inner surface of the film, forming a collection of small water droplets. Unfortunately, these water droplets often cloud the inner surface of the film, forming a “fog”, thus reducing the visibility of the food product through the film and resulting in a negative consumer perception. To reduce the negative effects of this “fog” additives that modify the surface properties of the film are added or applied to the film. These additives are often referred to as “antifog agents”. In a first approach one or more antifog agents are dispersed in the plastic film resin during processing of the film. Once in the film resin, the antifog agent tends to migrate to the surface of the film and raises the surface tension of the film. As a result, the condensed moisture on the film inner surface tends to form a relatively continuous film-like, transparent sheet of water rather than a fog. Another approach to minimize the negative effects of fogging on a film involves applying an antifog coating directly to the film's inner, food-facing surface.

A plastic packaging film often includes printed images on its outer surface to provide the consumer with visual information. The images are printed on the outer surface of the film, i.e. the one not facing the food product.

In the case of films provided with antifog properties, when the printed film is wound about a central core to form a roll, the printed side of the film contacts the non-printed side which contains the antifog agent. The contact between the printed surface and the antifog one causes a reduction of the antifog effectiveness of the antifog film specifically in the areas of contact between the inner, food-side surface of the film and the ink-covered printed region of the film's outer surface. As a result, when a printed antifog film is used to package a food product disposed on a tray, and the packaged food product is refrigerated, a fog forms on the inner surface of the film corresponding to the area that was in contact with the printed region when the film was rolled. On the other hand, in the area of the film's inner surface that did not contact the printed regions when the film was rolled, the antifog film appears to function as designed, that is it reduces the formation of fog. The final package thus shows opaque areas where the antifog agent does not function as designed and transparent ones in which the antifog prevents the formation of fog. The term “ghosting” refers to this contrast between transparent areas and opaque ones, because the fogged area on the film's inner surface forms a “ghost image” of the printed area on the film's outer surface.

It has to be observed that the printed regions on the outer surface of the film are not modified nor damaged by the contact and/or migration of the antifog agent from the film's inner surface.

A first objective of the present invention is therefore to provide a printed antifog film which, when used to package a refrigerated food product disposed on a tray, shows no ghosting. A second objective of the present invention is to provide a package comprising a food product disposed on a tray and a printed antifog film enclosing said product in the tray, which shows no ghosting when the package is stored in refrigerated conditions.

These and other objectives are achieved by the use of an overprint varnish that when applied over the printed image on the outer film's surface prevents the degradation of the antifogging properties of the antifog film. The overprint varnish of the present invention comprises a vinylidene chloride polymer and a surfactant.

The use of overcoats of various types, including coatings based on polymers comprising vinylidene chloride monomers, for the mechanical and environmental protection of printed images in photographic and imaging applications has been previously described for instance in EP-A-1,566,282, WO 95/29815, EP-A-1,069,470, EP-A-1,193,551, EP-A-1,413,453, EP-A-1,291,716 and EP-A-1,177,913. All of these documents however deal with the problem of protecting the printed images from mechanical and/or chemical degradation and not with the problem of preventing the degradation of the surface opposite the printed image when this surface is provided with antifog properties. Thus, there is still the need to provide a printed antifog film whose antifog properties are not damaged by the presence of printed images on the film's outer surface.

### DISCLOSURE OF INVENTION

According to a first object of the present invention there is provided a printed film comprising:
an antifog film having a first and a second surface;
a printed image on at least a portion of said first surface of said antifog film;
and an overprint varnish applied over said printed image wherein the overprint varnish comprises a vinylidene chloride polymer and a surfactant.

The term “antifog film” is used herein to indicate a plastic film that is provided of antifogging properties on at least one of its surfaces. The term “antifogging properties” is used herein to indicate the ability to reduce the visual effects of moisture condensation. In general the surface provided with antifogging properties is the surface of the film which faces the product, i.e. the food-side surface of the film.

Antifogging properties may be imparted to the film either by adding an antifog agent to the resin composition used for the manufacture of the film or by coating an antifog agent on at least one surface of the film or by performing both of these operations.

The antifog film may have one or more layers. Typically the antifog film has a total of from 2 to 20 layers, preferably of from 3 to 15 layers, more preferably of from 4 to 12 layers.

The antifog film may include any thermoplastic material, or resin, that is suitable for packaging food products. The antifog film may include multiple layers of the same or different resins in order to vary the physical properties of the film according to the desired end use. The antifog film may or may not be provided with gas barrier properties. In general the term “gas barrier” or “gas barrier layer” is used with reference to the ability of a film or film layer to serve as a barrier to one or more gases, preferably oxygen. For instance, a non-barrier multilayer antifog film may include a first outer layer, a core layer and a second outer layer. The first and second outer layers may have the same or a different composition. At least one of the two outer layers will have heat-seal and antifogging properties.

A typical gas barrier multilayer film may include: i) a food-side or heat-seal layer, ii) a non-food or outside layer (i.e., print side layer), iii) a gas barrier layer, iv) one or more adhesive layers, and v) one or more bulk layers.

The food-side/heat-seal layer may include one or more resins including ethylene homo- and co-polymers, propylene/ethylene copolymers, propylene/alpha-olefin copolymers, ethylene/unsaturated acid copolymers, ethylene/unsaturated ester copolymers and ionomers.

There are no particular limitations on the resin making up the non-food or outside layer of the film: it may include one or more resins including polyamides, polyesters, polystyrene, ethylene homo- and co-polymers, propylene homo- and co-polymers, and ionomers either alone or in combination.

The gas barrier layer may include one or more polymers having low permeability to oxygen, such as ethylene vinyl alcohol copolymer (EVOH), polyvinylidene chloride (PVDC), polyamides, or polyesters. Preferably, any barrier layer is an inner layer of the film.

The film may also include one or more bulk layers. Exemplary polymers used in bulk layers include ethylene homo- and co-polymers, propylene homo- and co-polymers, ethylene/unsaturated acid copolymers, ethylene/unsaturated ester copolymers, polyamides, polyesters, and ionomers. Also, a multilayer film may include one or more adhesive layers to provide increased adherence between the other layers. Exemplary polymers used in adhesive layers include chemically modified ethylene polymers for example, ethylene/unsaturated ester copolymers, such as alkyl acrylates or methacrylates, graft copolymers of maleic acid or anhydride onto ethylene/vinyl acetate copolymers, graft copolymers of fused ring carboxylic anhydrides onto polyethylene, resin mixtures of these and mixtures with ethylene homo- or copolymers.

When the antifog film comprises two or more layers the antifog agent may be incorporated in one or more of the layers of the film, preferably in one or more of the surface layers of the film.

The antifog agent may be incorporated in the resin, or resins, making up the film layer before or during extrusion. In particular, the antifog agent can be mixed intimately with the resins in which it is to be incorporated, when the extruder is loaded. Alternatively this step may be carried out beforehand, by mixing the resin and the antifog agent in a single- or twin screw extruder to produce an additivated product that will later be loaded as it is in the extruder. In a further alternative way, the antifog agent can be added in the form of a so-called “masterbatch”, a resin having a high concentration of antifog agent that will be mixed with the resin in which said composition is to be incorporated at the moment of extrusion and in an appropriate quantity to provide the desired percentage of the antifog agent. Suitable amounts of antifog agent in a film layer range from 0.5% to 12%, from 1% to 10%, from 1% to 8%, and from 1.5% to 6%, based on the total weight of the layer.

An antifog film may also be formed by applying to at least one surface of the film an antifog coating that contains one or more antifog agents in an effective amount. The antifog coating is typically applied only to the food-side surface of the film, to avoid coating the non-food side of the film with an agent that may reduce the adhesion of the ink that will be printed on the non-food side. Conventional techniques can be used for the application of the antifog agent to the film surface, like gravure coating, reverse kiss coating, fountain bar coating and spraying. The application of the antifog agent may be carried out either by an in-line method involving application during the manufacture of the antifog film or by an off-line coating method involving application after the manufacture of the film. Suitable amounts of antifog agent coated on the antifog film surface range from 0.1 to 8 mL/m², 0.5 to 7 mL/m², 0.5 to 5 mL/m².

Antifog agents known in the art belong to the class of surfactants, typically to the class of non-ionic surfactants. Suitable antifog agents fall into classes such as esters of aliphatic alcohols, polyethers, polyhydric alcohols, esters of polyhydric aliphatic alcohols, polyethoxylated aromatic alcohols, nonionic ethoxylates, higher fatty acid amines, higher fatty acid amides, polyoxyethylene ethers of higher fatty alcohols, ethylene oxide adducts of higher fatty acid amines or amides and hydrophilic fatty acid esters. Known antifog agents include polyoxyethylene sorbitan monostearate, polyoxyethylene sorbitan monolaurate, polyoxyethylene monopalmitate, polyoxyethylene sorbitan tristearate, polyoxyethylene sorbitan trioleate, poly(oxypropylene), polyethoxylated fatty alcohols, polyethoxylated 4-nonylphenol, polyhydric alcohol, propylene triol, propylene glycol, ethylene diol, glycerin fatty acid esters, mono- and/or diglycerides such as glycerol mono- and dioleate, glyceryl stearate, monophenyl polyethoxylate, and sorbitan monolaurate.

Blends of two or more surfactants may be used as antifog agent for the film of the invention. Compositions comprising a mixture of glycerol mono- and di-esters of saturated or unsaturated fatty acids and a further component such as propylene glycol or polyoxyethylene ethers of fatty alcohols provide films with good antifogging properties.

Antifog compositions comprising a glycerol mono-ester of a saturated or unsaturated fatty acid having from 8 to 20 carbon atoms, a glycerol di-ester of a saturated or unsaturated fatty acid having from 8 to 20 carbon atoms, and at least one polyoxyethylene ether of a fatty alcohol having from 8 to 20 carbon atoms and in particular compositions wherein the weight ratio of the combined esters to the weight of the ether is in the range of from 2:1 to 1:4 provide films with excellent antifogging properties.

Typically, the saturated or unsaturated fatty acid has from 12 to 20 carbon atoms and when it is unsaturated it may have one or more unsaturations. Examples of suitable fatty acids are lauryl acid, palmitic acid, stearic acid, oleic acid, linoleic acid, linolenic acid and the like. The mono-ester and the di-ester may be derived from the same fatty acid.

Generally the polyoxyethylene ether is a mixture of reaction products of ethylene oxide with one or more fatty alcohols having from 8 to 20 carbon atoms and, preferably, of products obtained by reacting from 2 to 5 moles of ethylene oxide per mole of fatty alcohol. Examples of suitable fatty alcohols are lauryl alcohol, myristyl alcohol, palmityl alcohol and stearyl alcohol and their mixtures.

The antifog film may be non-heat shrinkable or oriented to provide heat-shrink properties, wherein the term “heat-shrinkable” indicates a film which has a free shrink at 120° C. in at least one direction of at least about 5%, at least about 10% when measured according to ASTM D2732.

The antifog film may be of any thickness appropriate for providing the desired physical properties for the desired packaging application. Preferably, the antifog film has a total thickness of from 10 to 150 μm, of from 10 to 100 μm, of from 15 to 50 μm.

The antifog film may be manufactured by a variety of processes known in the art, including extrusion (e.g., blown-film extrusion, coextrusion, extrusion coating, flat-film extrusion, and lamination), casting, and adhesive lamination. A combination of these processes may also be employed. Examples of antifog films are described for instance in EP-A-739,398, EP-A-871,571 and WO 1984/03296.

The printed film of the invention comprises an image printed on at least a portion of one of its surfaces to provide the consumer with information regarding the product. The image is printed on the surface of the antifog film which will not be facing the food product in the package, i.e. the outer surface of the film. In general the printed image covers only a portion of the surface of the film to allow the consumer to visually inspect the content of the package.

The surface of the antifog film carrying the printed image may or may not have antifogging properties. Typically, when the antifog agent is provided in the form of a coating the printed surface of the film has no antifogging properties as the coating is applied only to the food-side surface of the film. When the antifog agent is incorporated into the resin(s) making up the layer(s) of the antifog film either one or both surfaces of the film may be provided with antifogging properties.

To improve the adhesion of the ink to the surface of the antifog film, all or only a portion of the surface of the antifog film may be treated or modified before printing to change the surface energy of the antifog film. Surface treatments and modifications include: corona treatment, plasma treatment, flame treatment and/or the application of a primer. Surface treatments and modifications are known to those of skill in the art. Typically the antifog film is treated to have a surface energy of at least about 0.038 J/m², preferably at least about 0.040 J/m², and more preferably at least about 0.042 J/m². A printed image is applied to the antifog film, preferably to the non-food side of the film. To form the printed image, one or more layers of ink are printed on the film.

The printed image may comprise a solvent-based ink, that is an ink that cures by evaporation of a solvent. Solvent-based inks for use in printing packaging films include a pigment dispersed in a vehicle that typically incorporates a resin, a solvent and optional additives. Preferably the inks comprise no waxes. Inks and processes for printing on plastic films are known to those of skill in the art. Examples of solvent-based ink resins include those which have nitrocellulose, amide, urethane, epoxide, acrylate, and/or ester functionalities. Ink resins include one or more of nitrocellulose, polyamide, polyurethane, ethyl cellulose, (meth) acrylates, poly (vinyl butyral), poly (vinyl acetate), poly (vinyl chloride), and poly(ethylene terephthalate). Ink resins may be blended. Examples of ink solvents include one or more of water or organic solvent, such as alcohols (e.g., ethanol, 1-propanol, isopropanol), acetates (e.g., ethyl acetate, n-propyl acetate), aliphatic hydrocarbons, aromatic hydrocarbons (e.g., toluene), and ketones.

The printed image may alternatively comprise a radiation-curable ink system, that is an ink that cures by a chemical reaction initiated by a radiation energy source, such as ultra-violet light or electron beam radiation. A radiation-curable ink system may incorporate one or more pigments, monomers and oligomer/prepolymers and optional additives.

Any conventional method may be used for the printing of the antifog film of the invention such as flexographic printing, gravure printing and the like.

It has been found that it is possible to reduce or eliminate the occurrence of “ghosting” typical of printed antifog films by applying over the image printed on the outer surface of the antifog film an overprint varnish comprising a vinylidene chloride polymer and a surfactant. The overprint varnish thus formulated is thought to reduce the migration of the antifog agent from the antifog film to the printed image while the film is wound up on a roll. Said migration is thought to cause a reduction in the availability of the antifog agent on the food-facing surface of the film.

As used herein, the term “vinylidene chloride polymer” refers to homopolymers of vinylidene chloride as well as to copolymers, terpolymers etc. of vinylidene chloride and one or more monoethylenically unsaturated monomers, wherein vinylidene chloride is the major component, and blends thereof.

Monoethylenically unsaturated monomers suitable for use in the present invention include alkyl acrylates, alkyl methacrylates, glycidyl acrylates or methacrylates, acrylic acid, methacrylic acid, vinyl chloride, acrylonitrile, unsaturated carboxylic acids, and unsaturated anhydrides. Preferably the monoethylenically unsaturated monomers are selected from the group of alkyl acrylates and alkyl methacrylates and vinyl chloride. Even more preferably the monoethylenically unsaturated monomer is vinyl chloride. In general the vinylidene chloride content is no less than 60 mole %, preferably no less than 75 mole %.

The overprint varnish of the invention may be applied over the printed surface of the antifog film from either a dispersion or a solution. Suitable vinylidene chloride polymer dispersions in water comprising from 40% to 70% by weight of solid vinylidene chloride polymer are for instance those sold by SolVin S. A. under the trade name Diofan A-036, Diofan A-115, Diofan A-297, Diofan A-050 or Diofan B-201.

The overprint varnish is preferably applied from a solution comprising from 5% to 50%, from 5% to 40%, from 7% to 30% by weight of solid vinylidene chloride polymer in the appropriate solvent, generally an organic solvent. Suitable vinylidene chloride polymers are for instance those sold by SolVin S. A. under the trade name Ixan PNE-613, Ixan PNE-288, Ixan SGA-1, which are provided as solids soluble in common organic solvents like acetates (e.g., ethyl acetate, n-propyl acetate), ethers (e.g., tetrahydrofuran) and aromatic hydrocarbons (e.g., toluene).

Suitable surfactants for the overprint varnish composition include anionic surfactants, cationic surfactants, non-ionic surfactants or amphoteric surfactants. Anionic surfactants are for instance alkylbenzene sulfonates, polyoxyethylene alkyl ether carboxylates, higher alcohol sulfates, polyoxyethylene alkyl ether phosphates or the like. Cationic surfactants include aliphatic amine salts, aliphatic quaternary ammonium salts, benzethonium chloride, pyridinium salts. Amphoteric surfactants comprise aminocarboxylates, lecithin, alkylamine oxide and the like.

The surfactant for the overprint varnish may conveniently be chosen from the same group of non-ionic surfactants suitable to confer antifogging properties to the antifog film. In particular the antifog agent can be chosen from one or more of the following classes of compounds: esters of aliphatic alcohols, polyethers, polyhydric alcohols, esters of polyhydric aliphatic alcohols, polyethoxylated aromatic alcohols, nonionic ethoxylates, higher fatty acid amines, higher fatty acid amides, polyoxyethylene ethers of higher fatty alcohols, and ethylene oxide adducts of higher fatty acid amines or amides and hydrophilic fatty acid esters. Suitable surfactants include polyoxyethylene sorbitan monostearate, polyoxyethylene sorbitan monolaurate, polyoxyethylene monopalmitate, polyoxyethylene sorbitan tristearate, polyoxyethylene sorbitan trioleate, poly(oxypropylene), polyethoxylated fatty alcohols, polyethoxylated 4-nonylphenol, polyhydric alcohol, propylene triol, propylene glycol, ethylene diol, glycerin fatty acid esters, mono- and/or diglycerides such as glycerol mono- and dioleate, glyceryl stearate, monophenyl polyethoxylate, and sorbitan monolaurate.

A possible surfactant for the overprint varnish composition belongs to the class of non-ionic ethoxylates, such as polyethoxylated derivatives of 4-nonylphenol.

Other possible surfactants for the overprint varnish comprise a mixture of mono- and di-glycerol esters of fatty acids. A suitable composition comprises a mixture of mono- and di-glycerol esters of fatty acids and propylene glycol.

Another composition comprises a mixture of mono- and di-glycerol esters of fatty acids and polyoxyethylene ether derivatives of fatty alcohols.

A particularly favourable surfactant composition comprises a glycerol mono-ester of a saturated or unsaturated fatty acid having from 8 to 20 carbon atoms, a glycerol di-ester of a saturated or unsaturated fatty acid having from 8 to 20 carbon atoms, and at least one polyoxyethylene ether of a fatty alcohol having from 8 to 20 carbon atoms wherein the weight ratio of the combined esters to the weight of the ether is in the range of from 2:1 to 1:4.

The surfactant used in the overprint varnish can be the same, partially the same or different from the antifog agent which confers the antifogging properties to the printed film.

The dry weight composition of the overprint varnish, i.e. the composition of the varnish on the surface of the film once the solvent has been dried off at the end of the process, comprises from 60% to 99%, from 65% to 95%, from 70% to 90% by weight of the vinylidene chloride polymer.

The dry weight composition of the overprint varnish comprises from 1% to 40%, from 5% to 35%, from 10% to 30% of the surfactant. The total amount of surfactant in the composition is typically from 5% to 45%, from 10% to 40% relative to the dry weight of the vinylidene chloride polymer in the overprint varnish.

The overprint varnish composition may further comprise other components such as waxes, antiblock additives and the like to improve the flowability, adhesion and surface characteristics of the varnish. Typical antiblock additives include silicas, zeolites, talc, calcium carbonate and insoluble organic particles, such as polytetrafluoroethylene particles.

A suitable overprint varnish composition comprises from 60% to 99% by weight of the vinylidene chloride polymer, from 1% to 40% of the surfactant and from 0% to 5% by weight of further additives, such as antiblock additives.

A preferred overprint varnish composition comprises from 65% to 95% by weight of the vinylidene chloride polymer, from 5% to 35% of the surfactant and from 0% to 5% by weight of further additives, such as antiblock additives.

The overprint varnish is applied over the printed image to obtain a dry coating weight of from 0.1 to 8 g/m², of from 0.2 to 6 g/m², of from 0.5 to 5 g/m², of from 0.7 to 3 g/m², of from 0.7 to 2 g/m².

The overprint varnish may be applied over the whole outer surface of the film or alternatively over only the portion of the surface covered by the printed image. Any conventional method may be used for applying the overprint varnish over the printed surface of the antifog film, such as flexographic printing, gravure printing and the like.

In a first embodiment of the printed film of the invention the antifog agent is incorporated in the resin(s) making up the food-side surface layer of the film. The amount of the antifog agent is from 2% to 4%, based on the total weight of the food-side layer of the antifog film. An image is printed using solvent-based inks on the surface of the antifog film that does not comprise the antifog agent. The overprint varnish applied over the whole surface of the film comprises 65% to 95% by weight of the vinylidene chloride polymer, preferably a copolymer of vinylidene chloride and vinyl chloride, 5% to 35% by weight of a surfactant and 0% to 5% by weight of an antiblock additive. The dry coating weight of the overprint varnish is from 0.7 to 2 g/m².

The surfactant in the overprint varnish has the same composition as the antifog agent present in the food-side layer of the film. A particularly effective surfactant/antifog composition comprises a glycerol mono- and di-ester component of a saturated or unsaturated fatty acid having from 8 to 20 carbon atoms and a polyoxyethylene ether of a fatty alcohol having from 8 to 20 carbon atoms, the weight ratio of the combined esters to the weight of the ether being about 2:1.

Alternatively, the surfactant in the overprint varnish has a different composition than the antifog agent present in the food-side layer of the film.

In a second embodiment of the printed film of the invention the antifog agent is incorporated in the resin(s) making up both surface layers of the film. The amount of the antifog agent is from 2% to 4%, based on the total weight of the layer of the antifog film. An image is printed using solvent-based inks on one of the two surfaces of the antifog film. The overprint varnish applied over the whole surface of the film comprises 65% to 95% by weight of the vinylidene chloride polymer, preferably a copolymer of vinylidene chloride and vinyl chloride, 5% to 35% by weight of a surfactant and 0% to 5% by weight of an antiblock additive. The dry coating weight of the overprint varnish is from 0.7 to 2.0 g/m².

The surfactant in the overprint varnish has the same composition as the antifog agent present in the film. A particularly effective surfactant/antifog composition comprises a glycerol mono- and di-ester component of a saturated or unsaturated fatty acid having from 8 to 20 carbon atoms and a polyoxyethylene ether of a fatty alcohol having from 8 to 20 carbon atoms, the weight ratio of the combined esters to the weight of the ether being about 2:1.

Alternatively, the surfactant in the overprint varnish has a different composition than the antifog agent present in the film.

The printed antifog film of the present invention is made by first providing an antifog film. The antifog film is obtained with conventional film forming techniques and comprises at least one surface provided with antifogging properties. The antifog film is then printed on one side, with solvent-based inks using a conventional printing method, like flexographic or gravure printing. The antifog film may be pretreated on at least one of its surfaces to improve the adherence of the inks and the overprint varnish. The antifog film is preferably pretreated by corona treatment to at least 0.040 J/m².

The overprint varnish is applied from a solution in organic solvents over the printed surface of the antifog film and dried in an oven to form a coated film. The varnish may be applied in the same printing operation as the inks or in a separate, subsequent operation. Preferably the overprint varnish is applied in the same printing operation as the inks, in the final print station of the printing process, using the same or a different printing technique.

According to a second object of the present invention there is provided a package comprising a food product, in particular a product having a high moisture content, placed in a suitable tray and enclosed with a printed antifog film, characterized in that a film according to the present invention is used. The printed film has a first and a second surface, a printed image on at least a portion of the first surface and an overprint varnish applied on the printed image. The overprint varnish comprises a vinylidene chloride polymer and a surfactant. At least the second surface of the film is provided with antifogging properties. The second surface of the film is arranged in the package to face the enclosed product. The first, printed surface of the film is arranged to be the non food-facing surface of the film.

Suitable trays may be made of monolayer or multilayer thermoplastic materials and they may be provided with gas barrier properties depending on the type of package. In case of a multilayer structure, part of it can be foamed and part can be cast. For instance, the multilayer material used to form the tray may comprise (from the outermost layer to the innermost food-contact layer) one or more structural layers, typically of a material such as foam polystyrene, foam polyester or foam polypropylene, or a cast sheet of e.g. polypropylene, polystyrene, poly(vinyl chloride), polyester or cardboard; a gas barrier layer, if needed, and a heat-sealable layer. The overall thickness of the tray is typically up to 10 mm, preferably comprised between 0.2 and 8 mm and more preferably between 0.2 and 7 mm.

The printed film may be wrapped around the tray to form a closed, hermetically sealed envelope. Packages of this type can be made using conventional horizontal form-fill-and-seal equipment. If the printed film is a heat-shrinkable one the envelope may be heat-shrunk around the tray to give a taut package by means of a heat-treatment at the end of the packaging process.

Alternatively the printed film may be sealed around the periphery of the tray. This type of package can be made using conventional tray-lidding packaging machines and processes. The tray used in this application is generally a gas barrier tray.

The packages obtained with the printed antifog films of the invention are free from “ghosting” and once refrigerated they allow a clear image of the packaged product within the package.

The invention is illustrated by the following non limiting examples.

### EXAMPLES

Throughout the examples the antifog effectiveness of a printed antifog film was evaluated by visually comparing a sample film, which had been exposed to controlled fogging conditions, to reference standards showing varying amounts and sizes of moisture condensate droplets on a film. The controlled fogging conditions are as follows: film samples are heat-sealed to the periphery of trays containing about 150 mL of water at a temperature of about 15° C. The trays are then placed in a refrigerator at a temperature of 2 to 4° C. and the formation of fog is monitored as well as its possible disappearance after 24 hours.

The results were assessed on a scale from 1 to 5 with the following meanings:
5=excellent—the bottom of the tray is clearly visible through the film and there are no drops of water on the film itself;
4=good—the bottom of the tray is clearly visible but a few droplets of water are present in a limited quantity on the surface of the film;
3=acceptable—the bottom of the tray can be seen in spite of the presence of a certain number of droplets on the surface of the film;
2=poor—it is difficult to see the bottom of the tray due to the considerable number of water droplets on the surface of the film;
1=very poor—it is impossible to see the bottom of the tray.

The antifog film used in the examples was a seven-layer heat-shrinkable film with a thickness of 25 μm having a symmetrical structure. The film comprised a food-side and a non food-side layer with the same composition comprising a blend of 66 wt. % of an ethylene/octene copolymer with a density of 0.920 g/cm³, 30 wt. % of an ethylene/octene copolymer with a density of 0.935 g/cm³. To this blend there was added a mixture of glycerol mono- and di-oleate, a mixture of ethers of polyoxyethylene with fatty alcohols (12-14 carbon atoms) and conventional antiblocking agents. The ratio by weight of the glycerol mono- and di-oleates with the ethers was about 2:1 and the total content of the antifog agent was about 3% of the total weight of the layer. The two external layers were coextruded with an internal barrier layer comprising 90 wt. % of EVOH and 10 wt. % of a polyamide 6/12 copolymer, two inner layers comprising 80 wt. % of a polyamide 6/66 copolymer and 20 wt. % of an ionomer and two intermediate adhesive layers made of a low density polyethylene modified with anhydride groups positioned between the polyamide layers and the external surface layers.

The overprint varnish composition used in the examples comprised as the vinilydene chloride polymer Ixan SGA-1 (SolVin S. A.), a copolymer of vinylidene chloride and vinyl chloride. The vinilydene chloride polymer (VdC) and the surfactant were dissolved in ethyl acetate. The overprint varnish solutions used in the examples contained from 15% to 17.5% by weight of the vinilydene chloride polymer and from 2.5% to 5.5% by weight of surfactant. The dry coating weight or the overprint varnish in each example ranged from about 1.2 to about 1.8 g/m².

### Example 1

The surface of the antifog film was corona treated to a surface tension of about 0.042-0.046 J/m² and then subjected to flexographic printing using a solvent-based ink (SunPeom, white, SunChemical). The overprint varnish was applied over the printed surface of the film in the final station of the flexographic press. After drying the film was wound on a roll and stored for at least one week before testing the antifogging properties.

### Example 2

The surface of the antifog film was corona treated to about 0.042-0.046 J/m² and then subjected to flexographic printing using a solvent-based ink (SunPeom, white, SunChemical). The overprint varnish was applied over the printed surface of the film in a subsequent step using a gravure process. After drying the film was wound on a roll and stored for at least one week before testing the antifogging properties.

### Examples 3-5

The surface of the antifog film was corona treated to about 0.042-0.046 J/m² and then subjected to gravure printing using a solvent-based ink (SunPly, white, SunChemical). The overprint varnish was applied over the printed surface of the film in the final station of the gravure press. After drying the film was wound on a roll and stored for at least one week before testing the antifogging properties.

### Comparative Example 1

The surface of the antifog film was corona treated to about 0.042-0.046 J/m² and then subjected to gravure printing using a solvent-based ink (SunPly, white, SunChemical). The overprint varnish comprising only the vinylidene chloride polymer was applied over the printed surface of the film in the final station of the gravure press. After drying the film was wound on a roll and stored for at least one week before testing the antifogging properties.

The dry weight composition of the overprint varnish in the examples and the antifogging performance of the samples in terms of overall antifog rating and ghosting are reported in Table 1.

When unwound from the roll none of the films of the Examples 1-5 and of Comparative Example 1 showed any deterioration in the quality of the printed image.

TABLE 1

| | VdC | Surfactant | | | |
|---|---|---|---|---|---|
| | (% dry | (% dry | Surfactant | Antifog | |
| | weight) | weight) | composition | Rating | Ghosting |
| Ex. 1 | 77 | 23 | 66.7% A + | 4.5-5 | No |
| | | | 33.3% B | | |
| Ex. 2 | 77 | 23 | 66.7% A + | 5 | No |
| | | | 33.3% B | | |
| Ex. 3 | 87 | 13 | 66.7% A + | 4.5-5 | No |
| | | | 33.3% B | | |
| Ex. 4 | 77 | 23 | 66.7% A + | 4.0 | No |
| | | | 33.3% B | | |
| Ex. 5 | 87 | 13 | C | 4 | No |
| Comp. | 100 | — | — | 3.5-4 | Yes |
| Ex. 1 | | | | | |

The chemical nature of the surfactants used in the examples is reported in Table 2.

TABLE 2

| Surfactant | | |
|---|---|---|
| A | glycerol mono- and di-oleate | Atmer 121, Ciba |
| | | Specialty Chemicals |
| B | ethers of polyoxyethylene with fatty | Dehydat LS 3 Deo N, |
| | alcohols (12-14 carbon atoms) | Cognis |
| C | sorbitan ester | Crillet 4, Croda |
| | | International |

The printed film of the present invention presents several advantages. The film displays a reduced tendency to forming a ghost image of the printed image after exposure to conditions that promote the formation of a moisture condensate on the film. The film thus provides a protective covering for a refrigerated packaged food product and allows the consumer a clear view of the stored food product without the disruption of a ghost image. The printed antifog film may be manufactured using conventional equipment by applying an overprint varnish in the final print station of the printing process with a low impact on the overall cost of the film.

1-10. (canceled)

11. A printed film comprising:
a. an antifog film having a first and a second surface;
b. a printed image on at least a portion of said first surface of said antifog film; and
c. an overprint varnish applied on said printed image;
wherein said overprint varnish comprises a vinylidene chloride polymer and a surfactant.

12. The film of claim 11, wherein said antifog film has antifogging properties on at least said second surface.

13. The film of claim 11, wherein said antifog film comprises an antifog agent incorporated in the resins making up at least one of its surface layers.

14. The film of claim 13, wherein said antifog agent in the antifog film and the surfactant in the overprint varnish are the same.

15. The film of claim 11, wherein said overprint varnish comprises 60% to 99% by weight of the vinylidene chloride polymer, 1% to 40% by weight of the surfactant, and 0% to 5% by weight of further additives.

16. An overprint varnish composition comprising 60% to 99% by weight of a vinylidene chloride polymer, 1% to 40% by weight of a surfactant, and 0% to 5% by weight of further additives, wherein said surfactant comprises a mixture of mono-glycerol and di-glycerol esters of fatty acids.

17. The overprint varnish composition of claim 16, wherein said surfactant comprises a mixture of mono-glycerol and di-glycerol esters of fatty acids and propylene glycol.

18. The overprint varnish composition of claim 16, wherein said surfactant comprises a mixture of glycerol mono-esters and di-esters of saturated or unsaturated fatty acids having from 8 to 20 carbon atoms, and a polyoxyethylene ether of a fatty alcohol having from 8 to 20 carbon atoms, wherein the weight ratio of the combined esters to the weight of the ether is in the range of 2:1 to 1:4.

19. The overprint varnish composition of claim 16, wherein said vinylidene chloride polymer is a copolymer of vinylidene chloride and vinyl chloride.

20. A package comprising a food product disposed on a tray and a printed film enclosing the product in said tray, wherein said printed film comprises:
a. an antifog film having a first and a second surface;
b. a printed image on at least a portion of said first surface of said antifog film; and
c. an overprint varnish applied on said printed image;
wherein said overprint varnish comprises a vinylidene chloride polymer and a surfactant, and wherein the printed surface of the film is the surface of the film not facing the product.
